(19) United States
(12) Patent Application Publication
(10) Pub. No.: US 2013/0135177 A1
(43) Pub. Date: May 30, 2013

(54) ELECTRONIC DEVICE, CONTROL METHOD FOR ELECTRONIC DEVICE, AND CONTROL PROGRAM FOR ELECTRONIC DEVICE

(71) Applicant: Junya TSURUOKA, Oume-shi (JP)

(72) Inventor: Junya TSURUOKA, Oume-shi (JP)

(73) Assignee: KABUSHIKI KAISHA TOSHIBA, Tokyo (JP)

(21) Appl. No.: 13/609,613

(22) Filed: Sep. 11, 2012

(30) Foreign Application Priority Data
Nov. 24, 2011 (JP) 2011-256850

(51) Int. Cl. G09G 5/00

(52) U.S. Cl. 345/1.3

(57) ABSTRACT

According to one embodiment, an electronic device includes: a first display configured to display an image; a second display configured to display and has lower power consumption than the first display; an application starting module configured to start an instructed application; and an output module configured to acquire display designation information that is included in the started application and designates a display for displaying the application, and output the started application to one of the first and second displays based on the acquired display designation information.

### CROSS-REFERENCE TO RELATED APPLICATION(S)

The application is based upon and claims the benefit of priority from Japanese Patent Application No. 2011-256850 filed on Nov. 24, 2011, the entire content of which are incorporated herein by reference.

### FIELD

Embodiments described herein relate generally to an electronic device, a control method for the electronic device and a control program for the electronic device.

### BACKGROUND

Recently, electronic devices capable of outputting and displaying the videos such as, for example, video images and still images or texts of electronic books on a display device have been distributed.

There is also a recent need for reduction of power consumption of such electronic devices.

In general, a relevant image display device (such as, for example, Liquid Crystal Display (LCD), liquid crystal display) is used for the video display.

Recently, it has been considered that a text display, such as an electronic paper or the like suitable for text display, is used to display texts and so on.

In addition, it has been known that the text display device such as the electronic paper generally has a lower power consumption than the image display device such as the LCD.

For this reason, there is a need to reduce power consumption of the electronic device by displaying the content on a proper display device depending on the type of the content. For example, when the content includes video images or still images, the content may be displayed on the image display device (LCD). However, when the content includes many texts, the content may be displayed in the text display device.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 is a view illustrating an appearance of an electronic device according to an exemplary embodiment.

FIG. 2 is a view illustrating an exemplary display including text in a display application (content) of the electronic device.

FIG. 3 is a view illustrating an exemplary display including image in the display application (content) of the electronic device.

FIG. 4 is a block diagram illustrating the configuration of the electronic device according to the exemplary embodiment.

FIG. 5 is a block diagram illustrating the configuration of a display of the electronic device according to the exemplary embodiment.

FIG. 6 is a view illustrating the exemplary embodiment in which the display application (content) is stored in a storage module.

FIGS. 7A and 7B is a view illustrating another exemplary embodiment in which a plurality of displays are allocated entirely to display the display application (content) based on the type of the display application.

FIG. 8 is a view illustrating the electronic device of another exemplary embodiment in which a plurality of displays are allocated entirely to display the display application (content).

FIG. 9 is a flow chart explaining the operation of the electronic device according to the exemplary embodiment.

FIG. 10 is a flow chart explaining the switching operation between applications in the electronic device according to the exemplary embodiment.

### DETAILED DESCRIPTION

According to an exemplary embodiment, an electronic device includes a first display used to display an image.

The electronic device further includes a second display used to display texts and has a lower power consumption than the first display.

The electronic device further includes an application starting module configured to start a designated application.

The electronic device further includes an output module which acquires display designation information, which is included in the started application and designates a display for displaying the application, and outputs the started application to one of the first and second displays based on the acquired display designation information.

Hereinafter, exemplary embodiments will be described with reference to the drawings.

In the present exemplary embodiment, an electronic device includes a first display used to display image and a second display which has lower power consumption than the first display.

The electronic device further includes an application starting module configured to start a designated application, and an output module configured to acquire display designation information included in the started application to designate a display and output the started application to one of the first and second displays based on the acquired display designation information.

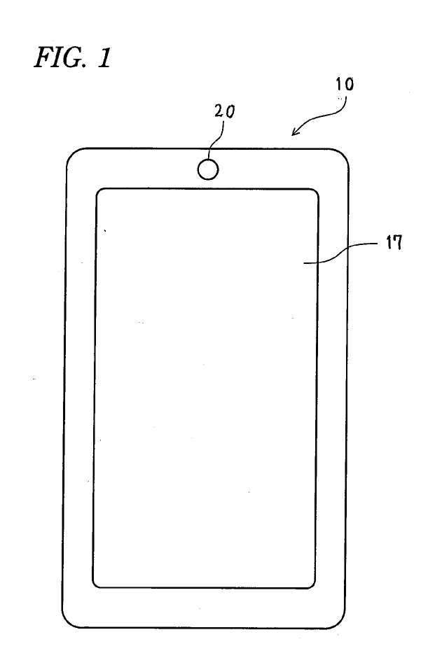

FIG. 1 is a view illustrating the appearance of an electronic device according to an exemplary embodiment.

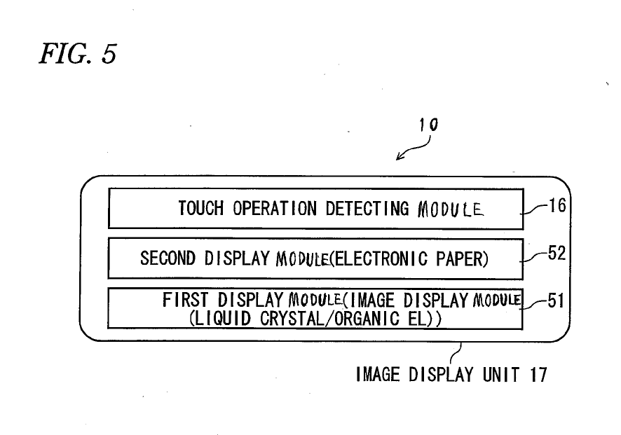

As shown in FIG. 1, an electronic device 10 includes a display 17 which includes a first display used to display the image and a second display which has lower power consumption than the first display, as shown in FIG. 5 and will be described later.

In the present exemplary embodiment, the electronic device 10 further includes a camera 20.

Herein, the electronic device 10 is a handheld device such as, for example, a personal computer (PC), a tablet PC, or a mobile phone, and may be applied to, for example, a television (TV).

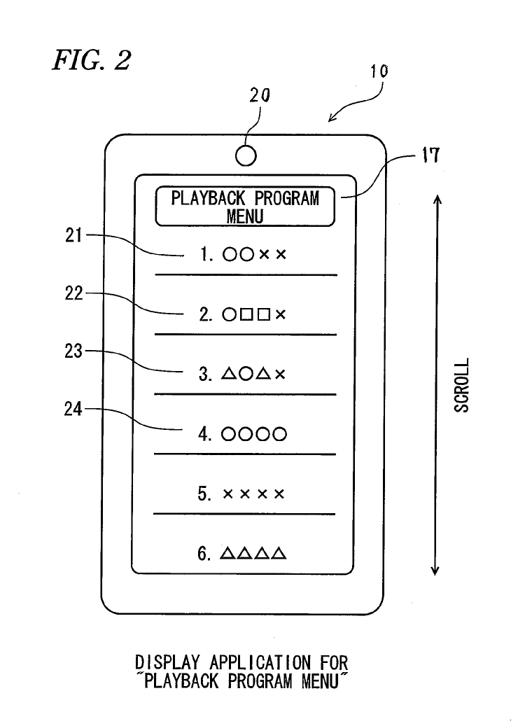

FIG. 2 is a view illustrating an exemplary display including text in a display application (content) of the electronic device.

For example, a display application (content) that displays a “playback program menu” is started and displayed on the display 17.

As described above, the display application for “playback program menu” is displayed on the second display which has lower power consumption than the first display.

Herein, the second display which has lower power consumption than the first display will be described according to the present exemplary embodiment.

Herein, for example, an electronic paper is used as the second display.

Descriptions will be made for the electronic paper hereinafter. The electronic paper has a characteristic of consuming less power both during display and rewriting, as compared to a display mainly used for displaying a video image.

The electronic paper displays content using reflected light as in paper. Accordingly, the electronic paper has a wide viewing angle and a high visibility, and the display application of the display is easily readable even when the display is exposed to, for example, a direct sunlight. In addition, the electronic paper gives little burden to eyes of a user.

In addition, the electronic paper can be made to be thin and flexible as in the paper.

At present, the electronic paper employs various types such as, for example, a micro capsule type, an electric liquid power type, a liquid crystal type, an electro-wetting type, an electrophoretic type, a chemical reaction type and so on.

For example, the electrophoretic type displays black and white by migrating black and white particles in a liquid-containing microcapsule using an electric field, and is also called as “particle migration type.”

Herein, the started display application (content) for “playback program menu” is displayed on the second display constituted by the electronic paper.

Herein, as shown in FIG. 2, the “playback program menu” is displayed on the display (the second display) 17.

For example, a program name “1. OOXX” 21, a program name “2. O□□X” 22, a program name “3. ΔOΔX” 23, a program name “4. OOOO” 24 and so on are listed mainly as texts.

For example, when the display (the second display) 17 is touched to perform a “flick” operation, a scroll of “playback program menu” can be displayed, as shown in FIG. 2.

As used herein, the “flick” operation refers to an operation that uses the touch panel and slightly slides a pen or a finger being contacted with a screen. For example, the “flick” operation may include an operation that touches the screen swiftly.

For example, a user may select a desired program content from the “play program menu” in the screen. In this case, for example, the program name “2. O□□X” 22 is selected.

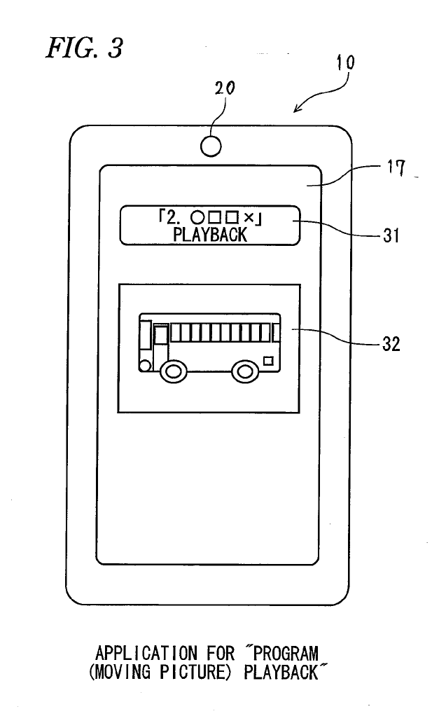

FIG. 3 is a view illustrating an exemplary display including image in the display application (content) of the electronic device.

Herein, the application (content) for “program (video image) playback” which displays the “playback program menu” is started and displayed on the display (the first display) 17.

In the present example, as described above, the program name “2. O□□X” 22 is designated from the “playback program menu” and this program (the program name “2. O□□X” 22) is played and displayed on the display (the first display) 17 other than the display (the second display) 17.

The display (the first and second displays) 17 will be described later with reference to FIG. 5.

Herein, a text “2. O□□X” play” 31 and an image 32 such as a video image are displayed on the display (the first display) 17 which are related to the program (the program name “2. O□□X” 22).

Herein, the program to be played is recorded in advance using, for example, the electronic device 10 and is stored in a storage module 109 which will be described later.

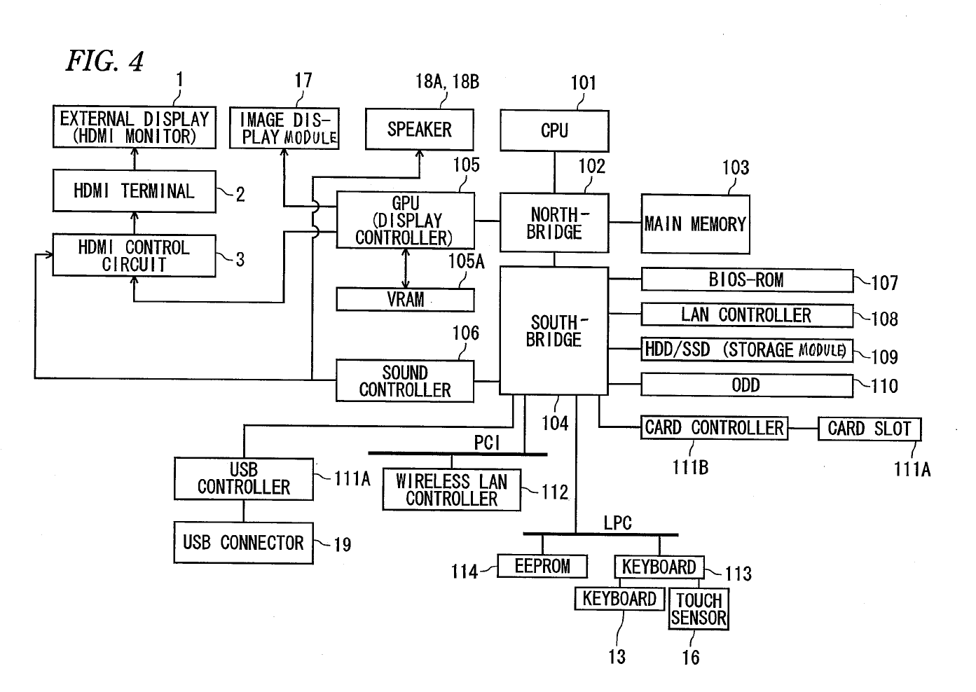

FIG. 4 is a block diagram illustrating the configuration of the electronic device 10 according to the exemplary embodiment.

The electronic device 10 includes a central processing unit (CPU) 101, a northbridge 102, a main memory 103, a southbridge 104, a graphics processing unit (GPU) 105, a video random access memory (VRAM) 105A, a sound controller 106, a basic input/output system-read only memory (BIOS-ROM) 107, a local area network (LAN) controller 108, a storage module (HDD/SSD) 109, an optical disk drive (ODD) 110, a USB controller 111A, a card controller 111B, a wireless LAN controller 112, an embedded controller/keyboard controller (EC/KBC) 113, an electrically erasable programmable ROM (EEPROM) 114 and so on.

The CPU 101 is a processor that controls the operation of each of the components of the electronic device 10.

The CPU 101 executes the BIOS which is a control program for hardware and stored in the BIOS-ROM 107.

The northbridge 102 is a bridge device that connects between a local bus of the CPU 101 and the southbridge 104. The northbridge 102 incorporates a memory controller that controls access to the main memory 103. The northbridge 102 also has a function to communicate with the GPU 105 via a serial bus of a PCI EXPRESS standard and so on.

The GPU 105 is a display controller that controls the display (the first and second displays) 17 used as display monitors of the electronic device 10.

A display signal generated by the GPU 105 is transmitted to the first and second displays 17. The GPU 105 may also transmit a digital video signal to an external display 1 via a HDMI control circuit 3 and a HDMI terminal 2.

The HDMI terminal 2 is a connection terminal for the external display as described above and may transmit an uncompressed digital video signal and audio signal to the external display 1 such as a television via a single set of cable. The HDMI control circuit 3 is an interface configured to transmit the digital video signal to the external display 1, which is referred to as a HDMI monitor, via the HDMI terminal 2.

The southbridge 104 controls each of the devices on a peripheral component interconnect (PCI) bus and on a low pin count (LPC) bus. The southbridge 104 also incorporates an integrated drive electronics (IDE) controller that controls the HDD/SSD (the storage module) 109 and the ODD 110.

The southbridge 104 also has a function to communicate with the sound controller 106.

The sound controller 106 is a sound source device and outputs audio data to be played to speakers 18A, 18B or the HDMI control circuit 3. The LAN controller 108 is a wired communication device that executes wired communication of, for example, the IEEE 802.3 standard, and the wireless LAN controller 112 is a wireless communication device that executes wireless communication of, for example, the IEEE 802.11g standard. The USB controller 111A executes communication with an external device connected via a USB connector 19 in compliance with, for example, the USB 2.0 standard.

For example, the USB controller 111A is used to receive an image data file stored in, for example, a digital camera. The card controller 111B executes writing/reading data to/from a memory card such as an SD card to be inserted in a card slot provided in a computer (notebook PC) main body 11.

The EC/KBC 113 is a single-chip microcomputer in which an embedded controller for power management and a keyboard controller that controls a keyboard 13 and a touch sensor 16 are integrated therein. The EC/KBC 113 has a function to power ON/OFF the electronic device 10 according to the operation of a power button 14 by a user.

In the present exemplary embodiment, the display control is performed, for example, when the CPU 101 executes a program stored in the main memory 103, the storage module such as the HDD/SSD (the storage module) 109 or the like.

Herein, for example, the display applications for “playback program menu” and for “program (video image) playback” are stored in the storage module such as HDD/SSD (the storage module) 109.

FIG. 5 is a block diagram illustrating the configuration of a display of the electronic device according to the exemplary embodiment.

As shown in FIG. 5, an image display 17 of the electronic device 10 has a touch operation detecting module 16, a second display (electronic paper) 52 and a first display (an image display such as liquid crystal display (LCD)/organic electroluminescence (EL) display) 51.

In the present exemplary embodiment, the first display 51 utilizes a image display suitable for displaying the image such as, for example, the LCD or the organic EL display.

Herein, the touch operation detecting module 16 is configured to be transparent and the content displayed in the second display (electronic paper) 52 or the first display (an image display such as the LCD/organic EL display) 51, is shown to a user through the touch operation detecting module 16.

As for the second display 52, for example, the electronic paper having lower power consumption than the first display 51 is used to be suitable for displaying the texts, as described above

In the present exemplary embodiment, as shown in FIG. 5, the first display 51 and the second display 52 are stacked with each other.

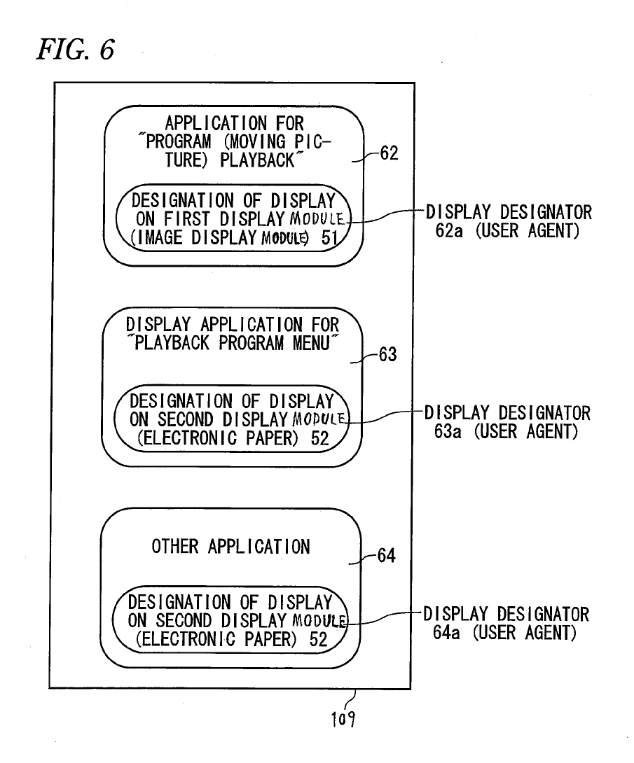

FIG. 6 is a view illustrating the exemplary embodiment in which the display application (content) is stored in a storage module.

As described above, the display applications (content) to be displayed on the display (the first and second displays) 17 of the electronic device 10 are stored in advance in the storage module such as, for example, HDD/SSD (the storage module) 109.

The display applications are controlled by the CPU 101 to be started and displayed on the electronic device 10.

In the present exemplary embodiment, as described above, an application 62 for “program (video image) playback”, a display application 63 for “playback program menu” or other application 64 is stored in the storage module such as HDD/SSD (the storage module) 109.

In the present exemplary embodiment, the application 62 for “program (video image) playback”, which is started and displayed on the electronic device 10, has a display designator 62a that designates a display which displays the application 62 for “program (video image) playback” (a display related to the application 62 for “program (video image) playback”). The display designator 62a is implemented with, for example, software, and is configured by, for example, a predetermined signal or data.

That is, herein, the display designator 62a of the application 62 for “program (video image) playback” designates a display on the first display (an image device) 51.

Similarly, the display application 63 for “playback program menu” has a display designator 63a that designates a display which displays the display application 63 for “playback program menu.”

The display designator 63a is also implemented with, for example, software, and is configured by, for example, a predetermined signal or data.

The display designator 63a of the display application 63 for “playback program menu” designates a display on the second display (electronic paper) 52.

Similarly, the other application 64 has a display designator 64a that designates a display which displays the other application 64. The display designator 64a is also implemented with, for example, software, and is configured by, for example, a predetermined signal or data.

The display designator 64a of the other application 64 designates a display on the second display (electronic paper) 52.

As an example of the above applications, for example, a web browser (Internet browser, WWW browser) may be used.

The web browser is a user agent which contributes to use the World Wide Web. The web browser may be simply called as a “browser.”

The user agent is software or hardware used when a user uses data based on a predetermined protocol, and may be called as a “consumer agent.”

For example, one of representative user agents is a “web browser” which accesses the World Wide Web using the HTTP. However, the term “user agent” is not limited thereto. For example, a user agent used when a user transmits/receives an electronic mail may be a mail user agent.

As described above, in the present exemplary embodiment, the application displayed on the electronic device 10 has its own display designator to designate a display to display the application.

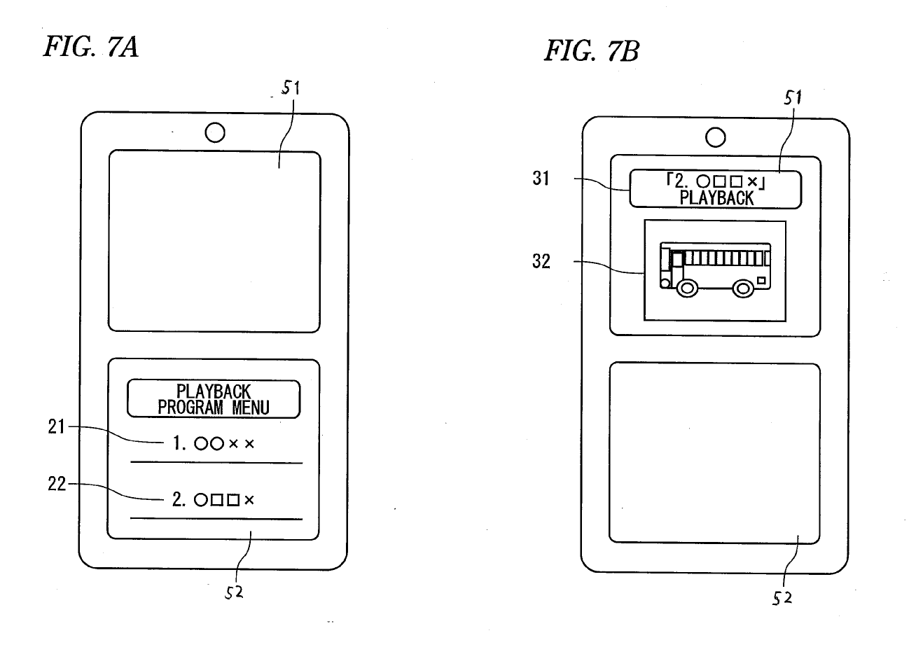

FIG. 7A and FIG. 7B are views illustrating another exemplary embodiments in which a plurality of displays are allocated entirely to display the display application (content) based on the type of the display application.

As shown in FIGS. 7A and 7B, the electronic device 10 has a plurality of displays, all of which are allocated.

Specifically, the electronic device 10 has, for example, the first display 51 constituted by an image display such as the LCD/organic EL display and the second display 52 constituted by, for example, an electronic paper, both of which are allocated.

In FIG. 7A, the display application (content) is a “playback program menu” application. The display application 63 for “playback program menu” is designated to be displayed on the second display (electronic paper) 52, as described above.

According to the designation, the display application 63 for “playback program menu” is displayed on the second display (electronic paper) 52.

In FIG. 7B, a display application (content) is a “program (video image) playback” application. The application 62 for “program (video image) playback” is to be displayed on the first display (LCD/organic EL display) 51, as described above.

According to the designation, the application 62 for “program (video image) playback” is displayed on the first display (LCD or organic EL display) 51.

In this manner, in the present exemplary embodiment, the display applications (content) are selectively displayed on the designated display, e.g., either on the first display 51 or the second display (electronic paper) 52.

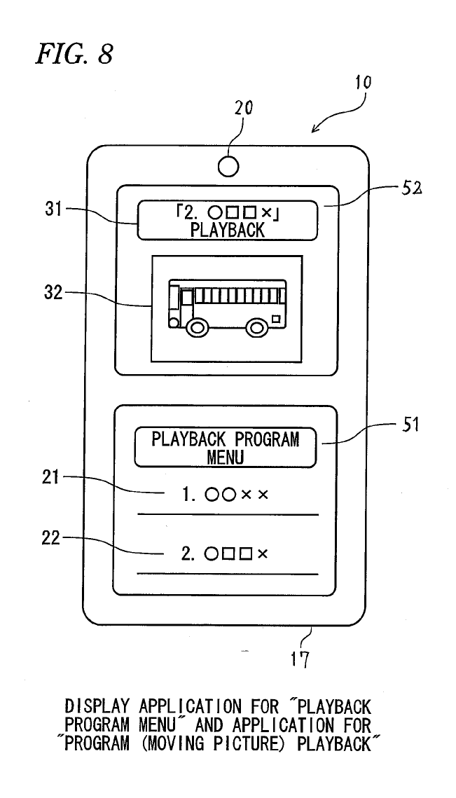

FIG. 8 is a view illustrating the electronic device of another exemplary embodiment in which a plurality of displays are allocated entirely to display the display application (content).

Herein, two applications including the display application 63 for “playback program menu” and the application 62 for “program (video image) playback” are displayed simultaneously.

The display application 63 for “playback program menu” is displayed on the second display (electronic paper) 52.

The application 62 for “program (video image) playback” is displayed on the first display (LCD or organic EL display) 51.

The present exemplary embodiment is equipped with different types of displays, so that different applications can be simultaneously displayed in each of the different types of displays.

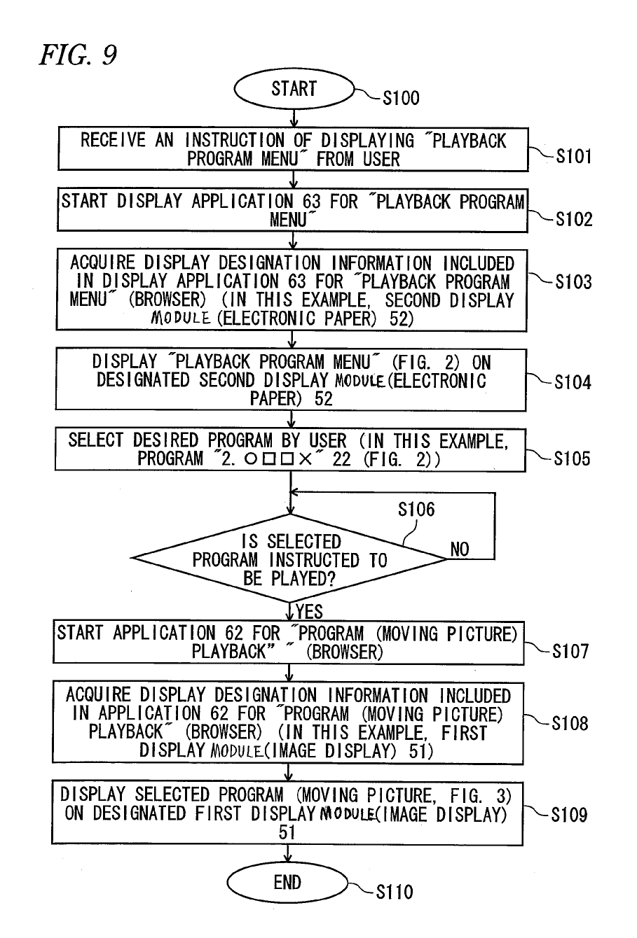

FIG. 9 is a flow chart for explaining the operation of the electronic device according to the exemplary embodiment.

At step S100, the operation is started. Subsequently, the operation proceeds to step S101.

At step S101, a “playback program menu” is instructed to be displayed by a user who operates the electronic device 10. Subsequently, the operation proceeds to step S102.

At step S102, the display application 63 for “playback program menu” (for example, the above-mentioned browser) stored in the storage module 109 is started. Subsequently, the operation proceeds to step S103.

At step S103, the CPU 101 of the electronic device 10 acquires display designation information included in the display application 63 for “playback program menu” (the browser). Herein, the second display (electronic paper) 52 is designated. Subsequently, the operation proceeds to step S104.

At step S104, the “playback program menu” (FIG. 2) is displayed on the designated second display (electronic paper) 52. Subsequently, the operation proceeds to step S105.

At step S105, the user selects a desired program from the program playback menu displayed on the display 17. Herein, the program “2. O□□X” 22 (FIG. 2) is selected. Subsequently, the operation proceeds to step S106.

At step S106, the CPU 101 determines whether the selected program is instructed to be played or not. If it is determined that the program is instructed to be played (“Yes” at step S106), the operation proceeds to step S107. If, however, it is determined that the program is not instructed to be played (“No” at step S106), step S106 is repeated.

At step S107, the application 62 for “program (video image) playback” (browser) is started. Subsequently, the operation proceeds to step S108.

At step S108, display designation information included in the application 62 for “program (video image) playback” (browser) is acquired. Herein, the first display 51 is designated as an image display. Subsequently, the operation proceeds to step S109.

At step S109, the selected program (video image, FIG. 3) is displayed on the designated first display 51. Subsequently, the operation proceeds to step S110.

At step S110, the operation is ended.

In this manner, in the present exemplary embodiment, an application to be started and displayed on the electronic device 10 has a display designator that designates a display which displays the application.

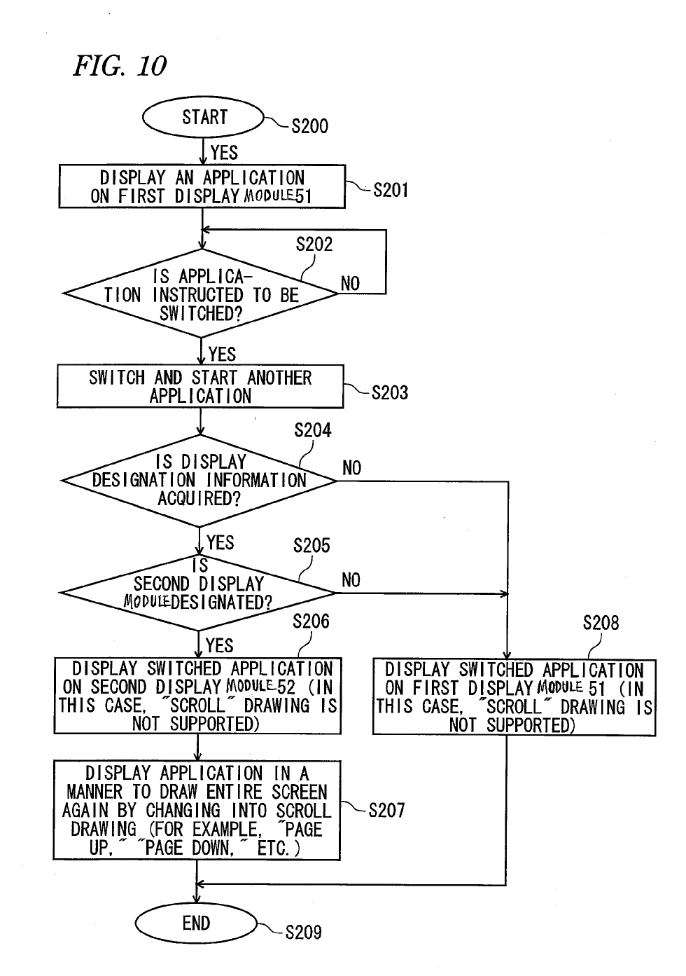

FIG. 10 is a flow chart for explaining the switching operation between applications in the electronic device according to the exemplary embodiment.

At step S200, the operation is started. Subsequently, the operation proceeds to step S201.

At step S201, a predetermined application is displayed on the designated first display 51. Subsequently, the operation proceeds to step S202.

At step S202, it is determined whether the electronic device 10 receives an application switching instruction or not. If it is determined that the application switching instruction is received (“Yes” at step S202), the operation proceeds to step S203. If, however, it is determined that the application switching instruction is not received (“No” at step S202), step S202 is repeated.

At step S203, the application is switched and started. Subsequently, the operation proceeds to step S204.

At step S204, it is determined whether the display designation information is acquired or not. If it is determined that the display designation information is acquired (“Yes” at step S204), the operation proceeds to step S205. If, however, it is determined that the display designation information is not acquired (“No” at step S204), the operation proceeds to step S208.

At step S205, it is determined whether the acquired display designation information designates the second display or not. If it is determined that the acquired display designation information designates the second display (“Yes” at step S205), the operation proceeds to step S206. If, however, it is determined that the acquired display designation information does not designate the second display (“No” at step S206), the operation proceeds to step S208.

At step S206, the switched application is displayed on the second display 52. In this case, “scroll” drawing is not supported. Subsequently, the operation proceeds to step S207.

At step S207, the application is displayed in a manner to draw the entire screen again by changing into the scroll drawing (for example, “Page Up,” “Page Down,” etc.) Subsequently, the operation proceeds to step S209.

At step S208, the switched application is displayed on the first display 51. In this case, “scroll” drawing is supported. Subsequently, the operation proceeds to step S209.

At step S209, the operation is ended.

In this manner, in the present exemplary embodiment, it is possible to reduce power consumption of the electronic device 10.

As described above, the electronic device of the present exemplary embodiment has the first display used for displaying the image, and the second display used for displaying the text and has lower power consumption than the first display.

The electronic device further includes the application starting module which starts an instructed application. The electronic device further includes the output module configured to acquire display designation information which is included in the started application and designates a display for displaying the application, and output the started application to one of the first and second displays based on the acquired display designation information.

The second display may be, for example, an electronic paper which can display the content using reflected light.

The first and second displays may be stacked with each other, as described above.

The first and second displays may be allocated together, as described above.

The application may be displayed in a manner to draw the screen again by changing the drawing into a scroll function when the application is displayed on the second display.

When the application is switched into another application, it is configured such that the switched application is output to one of the first and second displays based on the display designation information included in the switched application.

With this configuration, the electronic device 10 of the present exemplary embodiment can reduce its power consumption by displaying content on a proper one of a plurality of displays depending on the type of content.

The control process of the present exemplary embodiments may be performed entirely by software. Accordingly, the same effects as the above exemplary embodiments can be easily achieved if only a program to perform the control process is installed and executed by a typical computer via a computer readable storage medium storing the program.

The above exemplary embodiments are not intended to have a limited sense but may be modified and practiced in various ways without departing from the spirit and scope of the present invention.

Different inventions may be made with appropriate combinations of multiple elements described in the above exemplary embodiments.

For example, one or more elements may be deleted from the above exemplary embodiments. Elements of other embodiments may be combined as well.

What is claimed is:

1. An electronic device comprising:
a first display configured to display a first image;
a second display configured to display a second image, the second display having lower power consumption than that of the first display;
an application starting module configured to start up an application that is selected; and
an output module configured to acquire display designation information that is included in the application started by the application starting module and designates a display for displaying the application, and to output the started application to one of the first and second displays based on the acquired display designation information.

2. The electronic device of claim 1,
wherein the second display is configured to display content using reflected light.

3. The electronic device of claim 1,
wherein the second display is an electronic paper.

4. The electronic device of claim 1,
wherein the first and second displays are stacked with each other.

5. The electronic device of claim 1,
wherein the first display and the second display are arranged to be adjacent to each other.

6. The electronic device of claim 1,
wherein the second display is configured to display the second image in a manner to draw a screen again.

7. The electronic device of claim 1, wherein, when the application is switched into another application, the output module outputs the switched application to one of the first and second displays based on the display designation information included in the switched application.

8. A control method for an electronic device, the method comprising:
starting an application;
acquiring display designation information that is included in the application and designates a display for displaying the application; and
outputting the application to one of a first display used for displaying an image and a second display that has lower power consumption than the first display, based on the acquired display designation information.

9. A non-transitory computer-readable recording medium storing a computer executable program that, when executed, causes a computer to perform a control of an electronic device, the program comprising the steps of:
starting an application;
acquiring display designation information that is included in the application and designates a display for displaying the application; and
outputting the application to one of a first display used for displaying an image and a second display that has lower power consumption than the first display, based on the acquired display designation information.
